(19) United States
(12) Patent Application Publication
(10) Pub. No.: US 2009/0088357 A1
(43) Pub. Date: Apr. 2, 2009

(54) Device for fragrancing automatic dishwashers and for improving the pearl-off performace of the rinsing water during the drying phase

(76) Inventors: Hans-Jurgen Huppert, Leipzig (DE); Collin Berrido, Surrey (GB)

Correspondence Address: COLLARD & ROE, P.C., 1077 NORTHERN BOULEVARD, ROSLYN, NY, 11576, US

(21) Appl. No.: 11/920,517

(22) PCT Filed: Mar. 11, 2006
(86) PCT No.: PCT/EP2006/002259

§ 371 Date: Nov. 16, 2007

(30) Foreign Application Priority Data
May 30, 2005 (DE) 10 2005 025 041.6

(51) Int. Cl. C11D 9/44

(52) U.S. Cl. 510/103; 510/514

(57) ABSTRACT

An agent for use in dishwashers, which enables the dishwasher to be fragranced during protracted operating intervals and simultaneously improves the pearl-off performance of the rinsing water during the drying cycle, and which has a solid, preferably granular, structure at normal temperatures. The agent can be produced by exclusive use of a solid fragrance known per se. The solid fragrance contains a carrier material which is made of fatty alcohol or a mixture containing fatty alcohol and which is solid at normal temperatures, and, dissolved therein, a fragrance which is liquid at normal temperatures. The solution is composed quantitatively of between 40 and 60% by weight of carrier material and between 60 and 40% by weight of fragrance.

The present invention relates to an agent for use in automatic dishwashers and to a device for its dosed introduction during the rinsing and drying cycles for the purpose of fragrancing the inside of the dishwasher during protracted operating intervals and for improving the pearl-off performance of the rinsing water on washed items during the drying cycle, said agent having a solid, e.g. granular, structure at normal temperatures.

Consumer research shows that one- or two-person households run their dishwasher only twice a week. The reason for this is that only during this period do enough dirty items accumulate for a full or almost full dishwasher load. Thus, over a period of two, three or more days, the dishwasher is filled with items contaminated with leftovers. After just a short time, unpleasant odours develop inside the dishwasher, to which the consumers are exposed when they open the dishwasher in order to put in other dirty items. It is estimated that the consumer is exposed to these odours 8 to 10 times during an operating interval lasting several days.

Odour-improving agents for fragrancing dishwashers are known from the prior art. For example, Reckitt Benkiser and Henkel manufacture such products under the brand names “Calgonite” and “Somat Deoperls”. Reckitt Benkiser's product is based on a liquid fragrance formulation with up to 60% fragrance. This is held in a plastic reservoir and has a membrane through which the fragrance diffuses into the interior of the dishwasher. The disadvantage of this product is that the reservoir must be filled with large volumes of fragrance in order to ensure that the effect lasts for an adequate length of time, for example 30 days. This large volume is needed because of the high loss of liquid fragrance every time the dishwasher is operated, a consequence of the hot-water and hot-air temperatures during the rinsing and drying cycles. High costs are caused by the excessive introduction of fragrance. In addition, fragrance release while the product is in use is non-uniform, i.e., at first, the more volatile fragrance components are released. In consequence, the original smell of the fragrance undergoes a significant change while the product is in use, which does not promote acceptance of the product among consumers.

The Henkel product is based on the release of fragrance from a solid, granulated carrier material of ethylene vinyl acetate (EVA), a material of limited water solubility, which is described in DE 10237066. The maximum proportion of fragrance that can be incorporated in this carrier material is 40%. A special container described in DE 10303352 is utilized for releasing the fragrance in the dishwasher; this ensures release of the fragrance on contact with hot water and hot air during the dishwasher's rinsing and drying cycles. This is effected by way of the high water and air temperatures occurring during the dishwasher's rinsing and drying cycles. However, with this product the fragrance release is limited. The most significant disadvantage of this product is that a maximum fragrance content of 40% necessitates the use of large volumes of carrier material in order to maintain a sufficient fragrance intensity inside the dishwasher during operating intervals.

Another problem occurring in connection with the use of dishwashers is that there remains a “film” or spotting on items after washing, which is especially noticeable on glassware. This problem is particularly acute in localities in which the water supply has a high mineral content. Until now, this problem has been solved by the additional use—besides the washing-up agent and maybe an air freshener—of a product known as a rinse aid, which improves the degree to which rinsing water adhering to the washed items pearls off. An example of a commercially available product of this kind is “Finish”, produced by Reckitt Benkiser.

An immense disadvantage of the known air fresheners and rinse aids is that these products have to be put into the dishwasher as separate products, in addition to the actual washing-up agent.

The object of this invention is therefore to develop a product that allows not only the fragrancing of the dishwasher during protracted operating intervals, but also improves the pearling off of the rinsing water from the washed items, thus creating a shiny effect.

Another object of this invention is to provide a device that allows the dosed release of this agent in order to produce a combined fragrancing and shine effect during the dishwasher's rinsing and drying cycles. At the same time, this device should prevent any agglomeration of the chip-like, pearl-like or granular solid agent should operating temperatures reach 60° C. or more.

The problem of developing an agent for producing a combined fragrancing and shine effect is solved by the features of claim 1.

The problem of providing a device for releasing the agent during the dishwasher's rinsing and drying cycles is solved by the features of claim 7.

Preferred embodiments of the agent constitute the features of claims 2 to 6; preferred embodiments of the device for releasing the agent during the dishwasher's rinsing and drying cycles constitute the features of claims 7 to 9.

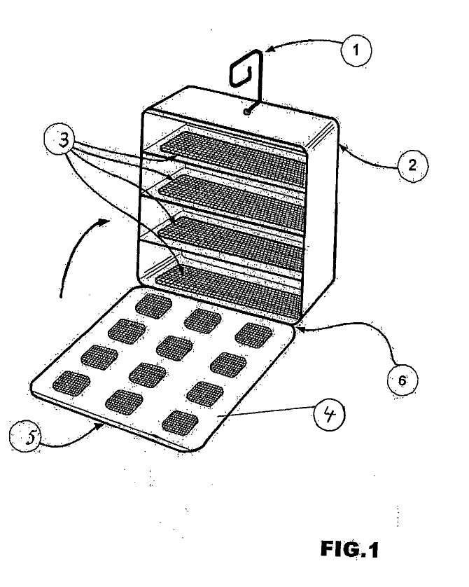

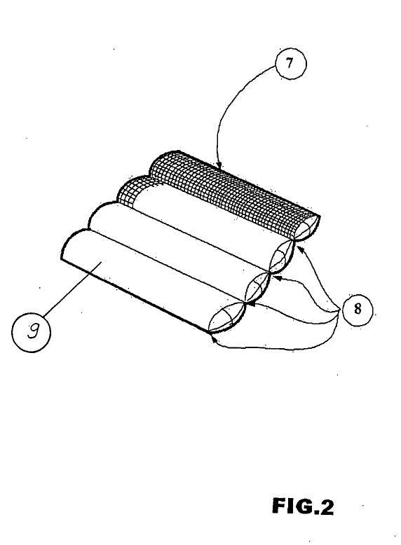

In the following, the invention will be explained on the basis of an embodiment, with reference to the drawings of FIGS. 1 and 2. The agent according to the invention comprises a carrier material, solid at normal temperatures, which consists of fatty alcohol or partly of fatty alcohol and makes up 40 to 60% by weight of the agent, and, dissolved in said carrier, a liquid fragrance that makes up 60 to 40% by weight of the agent. During the rinsing and drying cycles, during which the hot water or the hot air with temperatures of over 50° C. contacts the agent, the fragrance is released from the solid carrier material and fragrances the inside of the dishwasher. Simultaneously, when the solid carrier material comes into contact with hot water during the rinsing cycles, small amounts of fatty alcohol dissolve in the hot water and effectively improve the water's tendency to pearl off the washed items. As a result, the formation of a film or spots on the washed items, especially noticeable on glassware, is prevented. The surfaces of the washed items show a visible shine after drying.

The incorporation of liquid fragrances in a solid carrier material of fatty alcohol or a mixture of fatty alcohol and other components is described in the PCT application WO 2004/035721 and in the German patent application DE 10 2004 052 929.9, and this reference is intended to create a connection to the present invention. Surprisingly, it became apparent that the carrier material—in the form of fatty alcohol or a mixture of fatty alcohol and other components—selected for the incorporation of the liquid fragrance additionally has a positive influence on the water's pearl-off performance during the drying cycle. This is due to fatty alcohol dissolving in the rinse water.

A solution of fragrance in C22 fatty alcohol proved to be a particularly suitable agent.

It also became apparent that replacing up to 20 wt. % of fatty alcohol by surfactants derived from fatty alcohol ethylene/propylene oxide can further improve the effectiveness with which the rinsing water pearls off the washed items, without reducing the carrier material's capacity to incorporate fragrance. An example of a commercially available product which has the aforementioned composition and which can replace up to 20% of the carrier material is DEHYPON 3697 from Cognis-Care Chemicals. Although the choice of fatty alcohol or of substances containing a proportion of fatty alcohol, especially C22 fatty alcohol, as carrier material for the fragrance surprisingly ensures good pearl-off performance of the water, thus reducing film formation and spotting and consequently producing a shine effect, this effect is reinforced by the aforementioned addition of surfactants derived from fatty alcohol ethylene/propylene oxide.

For efficient release of both the fragrance and the substances that improve the rinse water's pearl-off performance, the invention provides for an innovative dispensing device suitable for attachment inside the dishwasher. This ensures good contact between the agent according to the invention and the water during the rinsing cycles, and prevents the solid carrier material within the dispensing device from agglomerating under its own weight at temperatures higher than 50° C., which are reached during the rinsing and drying cycles. If the carrier material were not prevented from agglomerating, the adequate release—during the dishwasher's running time—of fragrance and of the substances that improve the rinsing water's pearl-off performance could be increasingly impaired.

FIG. 1 illustrates an embodiment of a dispensing device according to this invention. It comprises a permeable, refillable unit containing the solid, granular, fragrance-imbued, water-pearl-off-improving agent.

FIG. 2 illustrates a further form of a dispensing device according to the invention. Provided with a suspension means, it can be suspended independently at an appropriate place inside the dishwasher, or, if the partitions in the device illustrated in FIG. 1 have been removed, it can be used as refill pouch for this device.

The device according to FIG. 1 essentially comprises a hook 1 that enables the device to be suspended, for instance from one of the racks inside the dishwasher. It also comprises a rigid body 2 with a sieve-like, permeable rear wall (not visible in FIG. 1). The rigid body 2 holds the granular material on a number of sieve-like partitions 3. The granular, fragrance-imbued solid agent, in the form of chips, pearls or pellets, is preferably applied as a single layer on each of the partitions 3. The device additionally comprises a sieve-like, permeable door 4, which is pivotable about a joint 6 and is connected firmly but detachably with the body 2 by a means 5, not shown in detail in FIG. 1, that self-locks with the body 2.

During the rinsing cycles, rinsing water flows through the sieve-like openings of the door 4 and the rear wall of the body 2 and dissolves the substance that improves the rinse water's pearl-off performance, i.e. the fatty alcohol and any surfactants that may be mixed therewith, which serves as carrier material for the liquid fragrance. Simultaneously, under the influence of heat, i.e. of hot water and, in particular, of the hot drying air flowing in after the rinsing cycles, the fragrance is released from the solid, granular structure of the agent according to the invention.

The fatty alcohol, and possibly further surfactants, dissolved in the dishwater permits a largely film-free and spotless pearling off of the rinsing water during the drying cycle, while the fragrance released from the granular agent by the drying heat provides a pleasant smell that lasts for several days inside the dishwasher, largely masking the unpleasant smell of items that are contaminated with leftovers and accumulate in the dishwasher over a few days.

If fragrances are used which simultaneously develop an antibacterial effect, for instance cineole or methyl phenyl butanol, the product according to the invention is imbued additionally with a deodorizing effect, meaning that unpleasant smells are not only masked but also combated. The invention thus makes it possible, without having to add special rinse aids or deodorizing agents, to confer a triple effect on the agent, which, in prior art products, only played a fragrancing role.

FIG. 2 illustrates an alternative embodiment of a device for dispensing the agent of the invention during the rinsing and drying cycles of dishwashers. This device likewise ensures that the granular agent cannot agglomerate when exposed to temperatures of over 50° C. inside the dishwasher during the rinsing and drying cycles.

This device is a pouch made of a semi-soft thermoplastic with sieve-like perforations. It is divided into a number of chambers 9 by spaced, seamlike, transverse heat seals 8. Since only small amounts of the granular agent are contained in each chamber, as in the case of the device of FIG. 1 with its partitions 3, the danger of the grains agglomerating under their own weight when exposed to temperatures above 50° C. is practically zero.

The embodiment of a dispensing device as illustrated in FIG. 2 can also be used as a refill unit for the device according to FIG. 1. The partitions 3 provided in the device illustrated in FIG. 1 are in this case unnecessary.

1-9. (canceled)

10. Device for fragrancing automatic dishwashers during protracted operating intervals and for simultaneously improving the pearl-off performance of the rinse water during the drying cycle, comprising a body (2), which is made of a rigid material and can be suspended in the dishwasher, and which has, in the suspended position, a vertical, sieve-like, permeable rear wall and a number of horizontal, sieve-like, permeable partitions (3) arranged at intervals inside the body (2), as well as a vertical, sieve-like, permeable front wall (4), which is detachably connected with the body (2), and the introduction into the body (2) of a solid fragrance, known per se, which comprises a carrier material of fatty alcohols or a mixture containing fatty alcohols, said carrier material being solid at normal temperatures, and, dissolved in said carrier material, a fragrance that is liquid at normal temperatures, the solution being composed quantitatively of between 40 and 60% by weight of carrier material and between 60 and 40% by weight of fragrance.

11. Device for fragrancing automatic dishwashers during protracted operating intervals and for simultaneously improving the pearl-off performance of the rinse water during the drying cycle, comprising a body (7) configured as a pouch made of a sieve-like, perforated semi-soft thermoplastic, which is subdivided into several chambers (9) by spaced, transverse, seam-like heat seals (8), and the introduction into the chambers (9) of the body (7) of a solid fragrance, known per se, which comprises a carrier material of fatty alcohols or a mixture containing fatty alcohols, said carrier material being solid at normal temperatures, and, dissolved in said carrier material, a fragrance that is liquid at normal temperatures, the solution being composed quantitatively of between 40 and 60% by weight of carrier material and between 60 and 40% by weight of fragrance.

12. Device for fragrancing automatic dishwashers during protracted operating intervals and for simultaneously improving the pearl-off performance of the rinse water during the drying cycle, comprising a body which is made of a rigid material and can be suspended in the dishwasher, and which has, in the suspended position, a vertical, sieve-like, permeable rear wall and a vertical, sieve-like, permeable front wall which is detachably connected with the body, wherein the body contains a refill unit in the form of the body (7) of claim 11, which is filled with solid fragrance known per se.

13. Device according to claim 10, wherein the fatty alcohol used is at least partially C22 fatty alcohol.

14. Device according to claim 10, wherein up to 20 wt. % of the carrier material are surfactants derived from fatty alcohol ethylene/propylene oxide.

15. Device according to claim 10, wherein up to 20 wt. % of the carrier material are modified fatty alcohol polyglycol ethers.

16. Device according to claim 10, wherein the fragrance has an additional, antibacterial effect.

17. Device according to claim 16, wherein cineole or methyl phenyl butanol is used as fragrance.
